(19) United States
(12) Patent Application Publication
(10) Pub. No.: US 2004/0221015 A1
(43) Pub. Date: Nov. 4, 2004

(54) Processing messages having categorized contents

(76) Inventors: Weiyun Sun, Vancouver, WA (US); Kenneth Charles Duisenberg, Roseville, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/426,395

(22) Filed: Apr. 30, 2003

(51) Int. Cl. G06F 15/16

(52) U.S. Cl. 709/207

(57) ABSTRACT

A message handling apparatus for handling messages communicated between components in a digital system has a message handler that receives messages generated by one or more components, with each message having a category identifier and a command identifier. The message handler accesses a data structure having an array including at least one category element and at least one list of one or more command elements. Each category element in the array corresponds to a category identifier and includes a reference to a list of one or more command elements. Each command element in the at least one list of one or more command elements corresponds to a command identifier. A message monitoring subsystem monitoring the frequency of occurrence associated with each command identifier can also be provided.

### BACKGROUND

Message handling has proven to be a difficult, processor-inefficient task that consumes large amounts of memory. This is particularly true for inter/intra-component messaging in digital systems with numerous components, for example, networks using so-called high-availability system architectures. High-availability systems can generally be characterized by a large quantity of redundant components. Should a component fail or otherwise become unavailable in such a system, a redundant replacement can be activated or accessed, preserving system integrity. This is especially important in the field of network/server systems where failures can cause delays, lost data and other undesirable consequences.

Today virtually any component of a digital system can send and receive messages. For example, components can be functionally complete computer systems, such as a host computer or network node, as well as various equipment such as processors/co-processors, storage devices, power supplies, memory devices, electromechanical devices such as cooling fans and chassis interlocks, etc. Components can include any of the above and other devices, systems, subsystems, assemblies, subassemblies, etc. To possess the capability to send and receive messages, such components comprise or utilize a digital element. For ease of description, the term component will refer to both, the operational component, and, if separately implemented, the digital element used for communicating messages on behalf of that operational component.

As the number of components in a high-availability system increases, there is a concomitant increase in the complexity of the operations required to monitor and control the components. Unfortunately, such message handling operations can require considerable processing, reducing operational throughput of the management subsystem. The requisite message processing increases further when there is more than one messaging protocol utilized in a system. This is not an uncommon phenomenon because historically there has been no standardization of protocols for monitoring and control messaging. One recent attempt to solve this problem has been the Intelligent Platform Management Interface (IPMI), an open-standard protocol developed by numerous component manufactures including Hewlett-Packard Company. IPMI defines a message protocol for messages communicated between network components such as a management subsystem, memory controllers, storage devices and the like. Typically, messages conforming to the IPMI protocol are used by a management subsystem to monitor operational and environmental characteristics, and to issue commands to control components. Although IPMI serves as a common protocol for component monitoring and control, it has failed to overcome the above-noted drawbacks characteristic of message handling.

### SUMMARY

In one aspect of the invention, an apparatus for processing messages communicated between components in a digital system is disclosed. Each message has a category identifier identifying a category of commands, and a command identifier identifying a command which is a member of the category identified by the category identifier. The apparatus comprises a message handler that receives component-generated messages; and a data structure, accessible by the message handler. The data structure comprises at least one list of one or more command elements, wherein the command elements within each list correspond to commands which are members of a same category. The data structure also comprises an array of at least one category element each corresponding to a category and including a reference to a command element list. The command elements in the referenced command element list each correspond to a command which is a member of the category which corresponds to the referencing category element.

In a further aspect of the invention, a data structure for use in processing messages communicated between components in a digital system is disclosed. Each message is defined as noted above. The data structure comprises at least one linked list of one or more command elements, wherein the command elements within each list correspond to commands which belong to a same command category. The data structure also comprises an array of at least one category element each corresponding to a category and including a reference to a command element list. The command elements in the referenced command element list each correspond to a command which is a member of the category which corresponds to the referencing category element.

In a still further aspect of the invention, a method for processing messages communicated between components in a digital system is disclosed. Each message is defined as having a category identifier identifying a command category, and a command identifier identifying a command which is a member of the command category identified by the category identifier. The method comprises: providing lists of command elements, the command elements within each list corresponding to commands belonging to a same category; and providing an array of category elements each corresponding to a command category and including a reference to a command element list, wherein the command elements in a command element list each correspond to a command which belongs to the category corresponding to the referencing category element.

In yet another aspect of the invention, an apparatus for processing messages communicated between components in a digital system is disclosed. Each message has a category identifier identifying a category of commands, and a command identifier identifying a command which is a member of the category identified by the category identifier. The apparatus comprises: message handling means for receiving component-generated messages; and a data structure, accessible by the message handling means, comprising at least one list of one or more command elements, wherein the command elements within each list correspond to commands which are members of a same category. The data structure also comprises an array of at least one category element each corresponding to a command category and including a reference to a command element list. The command elements in the referenced list each correspond to a command which is a member of the category which corresponds to the referencing category element.

In a further aspect of the invention, a computer readable medium having a set of computer executable instructions for handling messages communicated between components in a digital system is disclosed. Each message has a category identifier identifying a category of commands, and a command identifier identifying a command which is a member of the category identified by the category identifier. The set of computer-executable instructions comprises: message handling instructions that receives messages generated by one or more components. The computer readable medium further comprises computer-executable instructions that define an accessible data structure comprising: at least one list of one or more command elements, wherein the command elements within each list correspond to commands which are members of a same category, and an array of at least one category element each corresponding to a command category and including a reference to a command element list of one or more command elements each corresponding to a command which is a member of the category corresponding to the referencing category element.

### BRIEF DESCRIPTION OF THE DRAWINGS

FIG. 1 is a block diagram of a message handler according to one embodiment of the present the invention;

FIGS. 2A and 2B are a table describing command categories for IPMI messages that may be handled by the message handler of FIG. 1;

FIG. 3 shows the message handler of FIG. 1 subsequent to an optimized ordering of the command elements; and

FIG. 4 is a block diagram of an exemplary digital system in which the present invention can be implemented.

### DETAILED DESCRIPTION

The present invention is directed to the processing of messages having categorized contents which are communicated within a digital system. Such message handling operations can be performed, for example, to monitor and control components within a digital system. In specific embodiments, the message handling system and method of the present invention are directed to processing messages having a protocol conforming with the Intelligent Platform Management Interface (IPMI) specification. (See, IPMI Specification, version 1.5 dated Feb. 20, 2002, publicly available from, inter alia, Hewlett-Packard Company, the teachings of which are hereby incorporated by reference herein.) It will be appreciated from the following description, however, that the present invention may be implemented to process messages having categorized contents and which conform to any industry-standard or proprietary protocol.

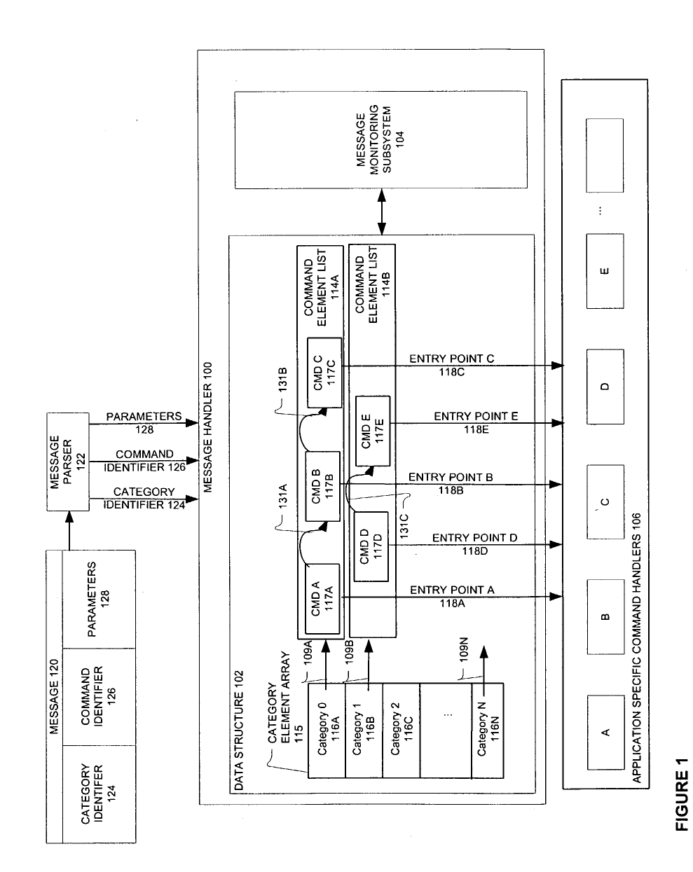

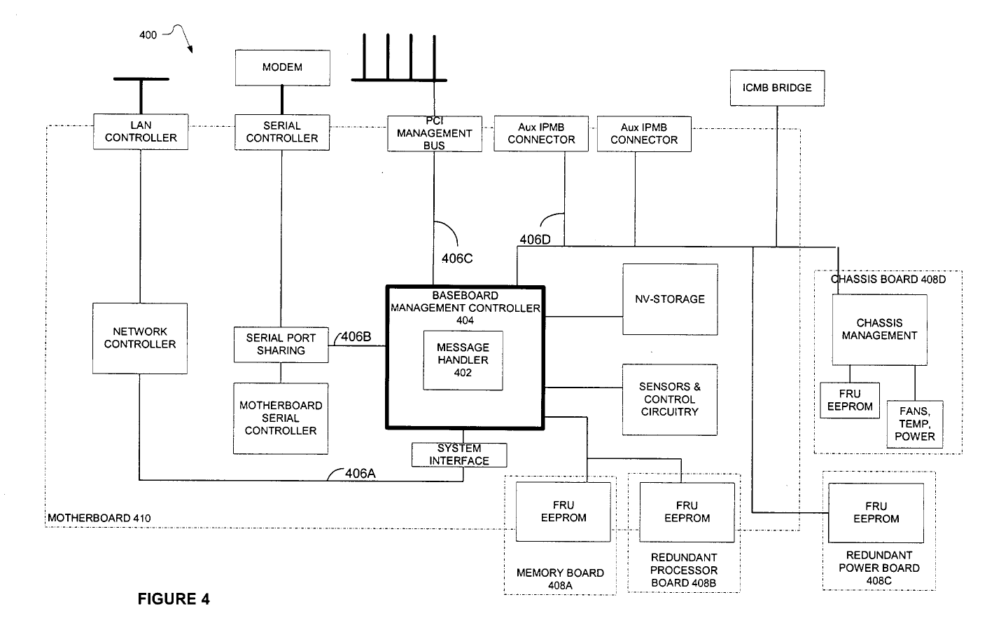

FIG. 1 is a schematic block diagram of one embodiment of a message handler 100 of the present invention. Message handler 100 generally resides within a digital system an exemplary implementation of which is described below with respect to FIG. 4. However, in one typical embodiment, message handler 100 is a driver implemented in software or firmware executed within a digital system. Message handler 100 receives a message 120 through the digital system to initiate an application specific command handler 106 based on information contained within the message. Message handler 100 can also include a message monitoring subsystem 104 which can monitor the operation of message handler 100 and, in some embodiments, improve the performance of the message handler as described below.

The commands that can be identified in message 120 are grouped into categories with each command category having one or more member commands. Each message 120 identifies which of those commands is to be initiated by message handler 100 in response to that message. A typical message 120 processed by message handler 100 comprises a command identifier 126 identifying the command which is to be executed, a category identifier 124 identifying the category which includes as a member the identified command and, perhaps, one or more command parameters 128 associated with the identified command. Parameters 128 can include, for example, control parameters, message return codes, error codes and any other command parameters as defined in the chosen protocol.

A message parser 122 can be employed to extract from message 120 category identifier 124, command identifier 126 and, if present, parameters 128. In the embodiment of message handler 100 illustrated in FIG. 1, message parser 122 is shown as residing outside of message handle 100. However, a person of ordinary skill in the art will recognize that parser 122 functionality could be included in message handler 100 as well.

Message handler 100 includes a data structure 102 that message handler 100 uses to process messages 120. Data structure 102 includes a category element array 115 and a number of command element lists 114. Category element array 115 includes a plurality of category elements 116, each of which corresponds to a command category that can be identified by category identifier 124. Each category element 116 includes a pointer 109 to one command element list 114. Each command element list 114 includes at least one command element 117 corresponding to a command which can be identified by a command identifier 126 of message 120. Commands corresponding to all command elements 117 of a command element list 114 are members of the same command category whose element 116 references that command element list 114. Each command element 117 has a pointer 118 to an application specific command handler 106 that executed the command corresponding to that command element. In the linked-list implementation shown in FIG. 1, each command element 117 also includes a pointer 131 to a next command element in the same command element list 114.

In operation, message handler 100 locates a command category element 116 in array 115 based on category identifier 124. Message handler 100 then sequentially traverses the command element list 114 referenced by the located category element 116 until the command element 117 identified by command identifier 126 is located. Message handler 100 then locates and initiates the application specific command handler 106 referenced by this command element 117. Message handler 100 passes parameters 128, if any, from message 120 to that handler 106 at initiation.

Preferably, the architecture implemented in data structure 102 is one which allows for rapid access to an identified category element 116 so that messages 120 can be quickly processed and the appropriate application specific command handler 106 executed. In the embodiment illustrated in FIG. 1, category array 115 is an array. However, other data structures can be used to store and access category elements 116. For example, a memory vector or other directly-addressable data structure can be used. In one preferred embodiment, each category element 116 can be directly accessed via an offset increment, and more preferably, each category element 116 can be addressed by using an address-offset from a base address. In one embodiment, category identifiers 124 can be numeric, and in particular, sequentially numbered. Thus, given a category identifier 124, the location of a corresponding category element 116 can be determined as an offset from a base category element. Referring to FIG. 1, for example, category 0 116A can be a base or 0^{th} category element. Then, the category element 116C corresponding to a category identified by a category identifier 124 of 2 would be located two elements from the 0^{th} element. As such, the location of the category element associated with each category is known or can be quickly determined, and that category element can then be directly accessed. In another preferred embodiment, category array 115 is allocated in size according to the number of category elements 116 to be stored therein. Further, while illustrated category element array 115 is local to message handler 100, category array 115 can be located or otherwise stored in a centralized database, on a networked node, or any other location accessible to message handler 100.

In one embodiment, contiguous memory or storage is allocated for command elements 117 within a command element list 114. Such an implementation reduces access time required to locate each next command element 117 in a list 114. It should be appreciated, however, that linked lists are typically stored in non-contiguous memory locations. Further, because the number of command elements 117 in each list 114 is typically predetermined for a particular message handler 100, memory allocation for each command element list 114 can be minimized. For example, in a list 114 with 10 command elements 117, an allocation sufficient only for 10 command elements could be considered optimal. Similar to category array 115, command lists 114 need not be stored local to the message handler 100, but can be located or otherwise stored in a centralized database, on a networked node, or any other location accessible by message handler 100.

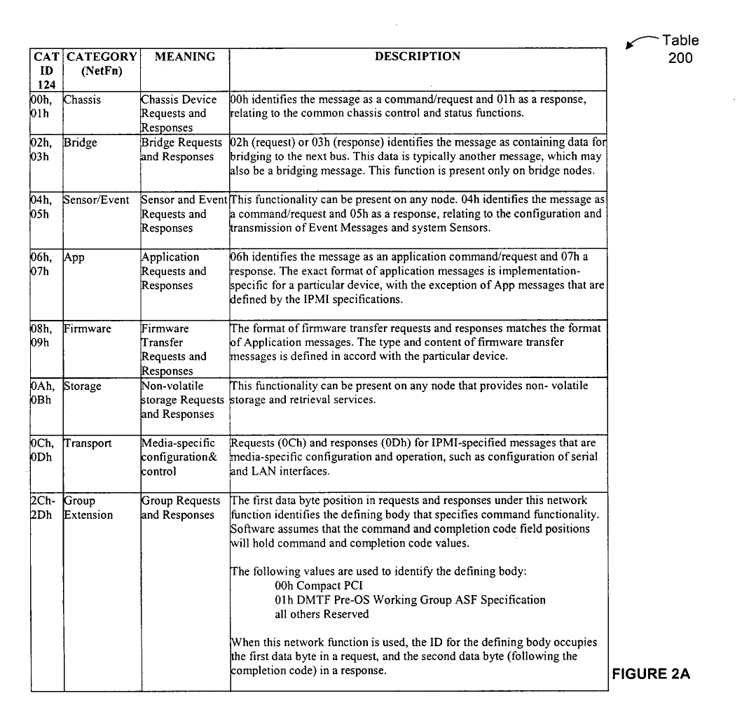

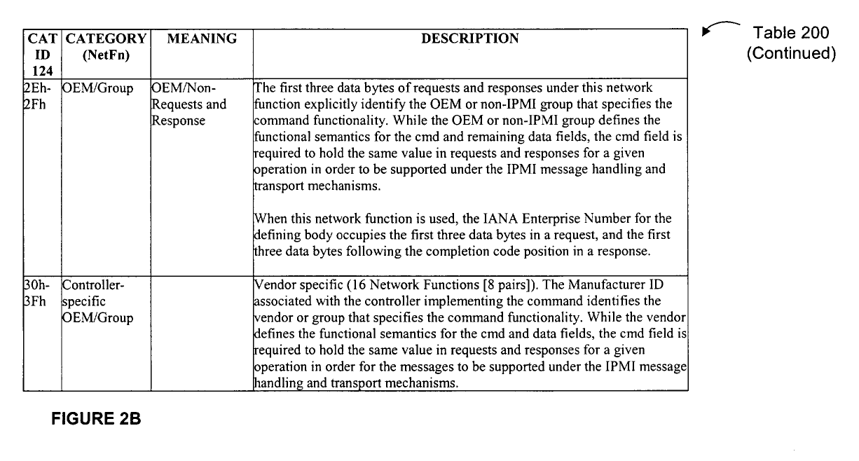

One example of the contents of messages 120 will now be described with reference to FIGS. 2A-2B. As noted, messages 120 contain categorized contents. In the exemplary application of component monitoring and control, such message contents are commands. As such, messages 120 include command identifiers 126 and command category identifiers 124, as described above. Commands can be categorized based on component type, function and/or operation or other criteria criterion depending on the digital system in which the messages are implemented. For example, a command category may comprise commands related to monitoring and control of redundant power supplies. Another command category may comprise component monitoring commands related to temperature, voltage-levels and cooling fan speed sensors.

In a preferred embodiment, command categories and commands correspond to those defined in the Intelligent Platform Management Interface specification (IPMI), noted above, or in future versions of that specification. All IPMI messages share the same identification fields in message 120 (e.g., category identifier 124, command identifier 126 and parameters 128) regardless of the transport protocol utilized for message communication. This provides portability of message handlers 100 among numerous components within the digital system. Such message handlers 100 can potentially operate with a different application specific command handler 106 depending on the component functionality to be controlled by messages 120.

FIGS. 2A and 2B are a table describing command categories for IPMI messages that may be handled by message handler 100 of FIG. 1. According to IPMI, a command category 124 is defined according to whether the message 120 is a request message or a response message. The request and response messages 120 are grouped together and assigned a Network Function Code (NetFn). For example, one command category is “chassis device request” with a category identifier 124 of 00h, and another command category is “chassis device response” with a category identifier 124 of 01h. These two categories, described at row 1 of table 200, are assigned a “Chassis” NetFn code.

Shown in Table 200 are 32 IPMI categories defined for IPMI-compliant components. Table 200 enumerates IPMI category identifiers, NetFn names, a brief meaning of the category description, and description of each defined category. In accordance with the IPMI specification, each command category can have up to 256 member commands. Hence, each message has a numeric category identifier between 0 and 31 (e.g., each category identifier is an offset from a base element corresponding to category 0) and an associated command list of 256 or less command elements. Further, a message can have optional parameters 128, as noted above.

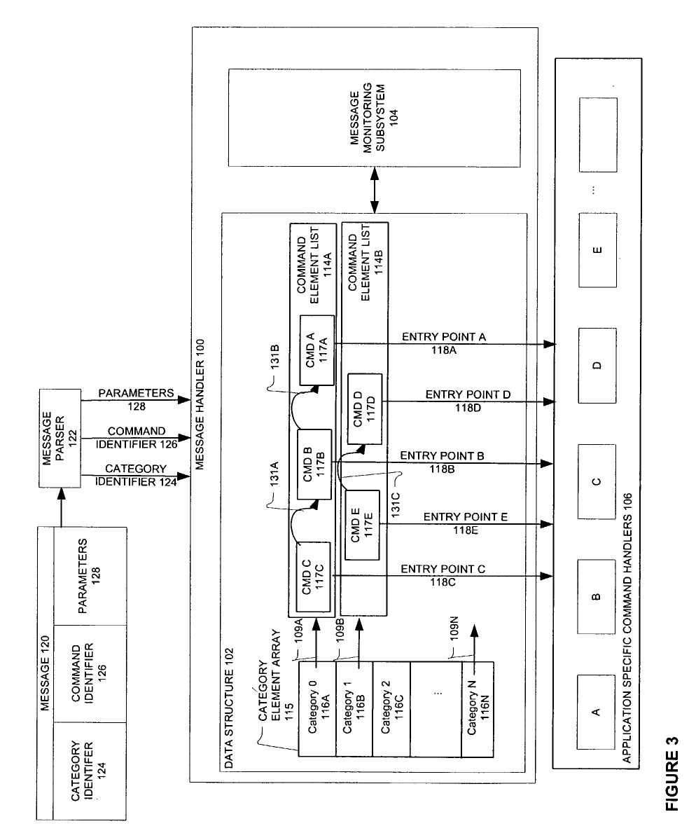

FIG. 3 is a schematic block diagram of message handler 100 subsequent to a reordering of command elements 117 in command element lists 114. As noted, a message monitoring subsystem 104 can be provided to optimize data structure 102. Monitoring subsystem 104 can monitor, for example, message traffic and/or the processing functions of message handler 100. From such monitoring, subsystem 104 gathers metrics which can be used to reorder or sort command elements 117 to achieve a desired improvement in the efficiency of message handler 100. In one embodiment such metrics include those which provide some which are indicative of future invocation of command handlers 106. For example, in one particular embodiment, the frequency of occurrence for each command identifier 126 received by message handler 100 is monitored and retained by monitoring system 104 for use as described below.

Message monitoring subsystem 104 can continuously, periodically, or upon request or other event, sort or re-order command elements 117 within one or more command element lists 114 based on the gathered metrics. It should be appreciated that monitoring subsystem 104 need not be operating in real-time, but may read metrics from a database or memory locations used to store an average of such metrics. Thus, for example, frequently accessed command elements 117 can be moved forward in a command element list 114 (to the left in FIGS. 1 and 3), and command elements 117 which are less frequently accessed can be moved rearward in the command element list 114 (to the right in FIGS. 1 and 3). With this reorganization, message handler 100 will rapidly locate in a list 114 a command element 117 that corresponds to a frequently-invoked command. If the past frequency of occurrence of a command is predictive of future occurrences, such a reordering of command element lists 114 optimizing data structure 102 and reduces the time required to process messages 120.

It should be understood that this rearrangement is based on the conventional search technique of starting at the beginning of a linked list of elements and sequentially traversing the list until the desired element is located. It should therefore be appreciated that in alternative embodiments message monitoring system 104 sorts and/or re-orders command elements 117 based on the implemented search algorithm to reduce to time required to access a desired command element 117 in a command list 114.

The results of the operations performed by monitoring subsystem 104 are demonstrated by comparing the ordering of command elements 117 within command element lists 114 illustrated in FIGS. 1 and 3. Each of FIGS. 1 and 3 shows two command element lists 114: a first command element list 114A associated (via pointer 109A) with category 0 116A, and a second command element list 114B associated (via pointer 109B) with category 116B. In FIG. 1, an initial or baseline ordering of command elements 117 is illustrated. Command elements 117 are ordered sequentially based on their alphabetic values (i.e., example command element list 114A is ordered to have command A (117A) first in the list, followed by command B (117B), and then followed by command C (117C)). Of course, other baseline orderings can be accomplished using a “best guess” or historical survey of other systems of similar usage or configurations.

FIG. 3 shows the data structure 102 of FIG. 1 after a re-ordering of the command element lists 114 by one embodiment of message monitoring subsystem 104. In particular, FIG. 3 illustrates the two command element lists 114A and B of FIG. 1 reordered by message monitoring subsystem 104. The first command list 114A associated with category 0 116A is now ordered as command element C 117C, then command element B 117B and then command element A 117A. The ordering of FIG. 3 reflects an exemplary message handler 100 where a frequency metric is used by message monitoring subsystem 104 to predict frequency of future access. The metric indicates that command identifier C is received more frequently than command identifier B, with command identifier A received least frequently. Similarly, the second command element list 114B is reordered to have command element E 117E first, then command element D 117D, indicating that command identifier E has been received more frequently than command identifier D.

The ordering of FIG. 3 thus presents an optimized solution providing minimal processing time for accessing command elements 117 within command element lists 114. Because frequently-accessed command elements 117 are moved forward of elements 117 that accessed less frequently, on average, shorter, more rapid traverses along each list are performed to locate a command element 117. Further, when employed dynamically, re-ordering of command elements 117 accounts for any change in use, such as configuration and/or component changes. As noted, re-ordering can occur periodically, upon request, or upon an event, such when a reconfiguration occurs. Further, re-ordering can occur as a background task, thus minimizing processing functionality directed to other tasks.

FIG. 4 is an exemplary digital system 400 in which the message handler system and method of the present invention can be implemented. Digital system 400 comprises a message handler 402 capable of handling categorized messages as described above. Digital system 400 has a motherboard 410 with a baseboard management controller 404 which manages various components 408. Components 408 generate messages 120 having a category identifier 124 and a command identifier 126 in accordance with the IPMI protocol and as described above with reference to FIGS. 1 and 2. Messages 120 are received by baseboard management controller 404 which parses received messages 120 to extract category identifier 124 and command identifier 126. Message handler 402 receives the identifiers 124, 126 and processes them as described above.

Message handler 402 receives messages 120 from a number of illustrated local or remote components such as memory boards 408A, redundant processor boards 408B, redundant power supply boards 408C, and chassis boards 408D. Such components are illustrated as dashed rectangles in FIG. 4. As noted above, motherboard 410 is also a component but in this exemplary embodiment, message handler 402 exchanges messages from components 408 only. It should appreciated as well, however, that components can be internal to motherboard 410 as long as they are in communication with the baseboard management controller 404.

Busses 406 transport messages 120 between components 408 and baseboard management controller 404 in accordance with any known transport protocol such as TCP/IP. Transport protocol processing is performed by baseboard management controller 404 in any manner as is conventionally known.

Baseboard management controller 404 additionally parses message 120 to extract category identifier 124 and command identifier 126. Parameters 128 are also parsed, if present in message 120. Message handler 402 receives identifiers 124, 126 and parameters 128 and accesses a data structure 102 having a category element array 115 of category elements 116, each such element representing a category described above with reference to FIG. 2. Using category identifier 124, a category element 116 representing the identified category is accessed, and a pointer 109 therein locates a command element list 114 associated with that category. The associated command element list 114 is traversed until a command element 117 corresponding to the command identifier 126 is located. An application specific message handler 106 is initiated according to an entry pointer 118 within command element 117. Hence, the message is processed.

A person of ordinary skill in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entity.

What is claimed is:

1. An apparatus for processing messages communicated between components in a digital system each message having a category identifier identifying a category of commands, and a command identifier identifying a command which is a member of the category identified by the category identifier, the apparatus comprising:
a message handler that receives component-generated messages; and
a data structure, accessible by the message handler, comprising:
at least one list of one or more command elements, wherein the command elements within each list correspond to commands which are members of a same category, and
an array of at least one category element each corresponding to a category and including a reference to a command element list, wherein the command elements of the referenced list each correspond to a command which is a member of the category which corresponds to the referencing category element.

2. The apparatus of claim 1, wherein each command element comprises:
a reference to an application specific command handler which executes the command corresponding to that command element.

3. The apparatus of claim 1, further comprising:
a message monitoring subsystem configured to order the command elements within each command element list such that command elements likely to be accessed relatively more frequently can be located by the message handler more quickly than command elements likely to be accessed relatively less frequently.

4. The apparatus of claim 1, wherein each command element list is a linked list.

5. The apparatus of claim 4, wherein each linked list is allocated a size in a memory according to a number of command elements in the linked list.

6. The apparatus of claim 1, wherein the messages further include parameters associated with the command identified by the command identifier of that message.

7. The apparatus of claim 1, wherein the messages conform to an intelligent platform management interface (IPMI) protocol.

8. A data structure for use in processing messages communicated between components in a digital system, each message having a category identifier identifying a category of commands, and a command identifier identifying a command which is a member of the command category identified by the category identifier, the data structure comprising:
at least one linked list of one or more command elements, wherein the command elements within each list correspond to commands which belong to a same command category; and
an array of at least one category element each corresponding to a command category and including a reference to a command element list, wherein the command elements in the referenced list each correspond to a command which is a member of the category which corresponds to the referencing category element.

9. The data structure of claim 8, wherein command elements within each at least one linked list comprise:
a reference to a next command element in the linked list; and
a reference to an application specific command handler which executes the command corresponding to the command element.

10. The data structure of claim 8, wherein each linked list is allocated a size in a memory according to a number of command elements to be stored in the linked list.

11. The data structure of claim 8, wherein command elements within each linked list are ordered according to a frequency at which the one or more command elements are likely to be accessed.

12. The data structure of claim 11, wherein command elements within each linked list are re-ordered according to changes in the frequency at which the one or more command elements are accessed over a time period.

13. The data structure of claim 11, wherein the at least one linked list is traversable in a forward direction, and wherein command elements with a higher frequency of occurrence are ordered forward of command elements within the linked list having a lower frequency of occurrence.

14. A method for processing messages communicated between components in a digital system, each message having a category identifier identifying a command category, and a command identifier identifying a command which is a member of the command category identified by the category identifier, the method comprising:
providing lists of command elements, the command elements within each list corresponding to commands belonging to a same category; and
providing an array of category elements each corresponding to a command category and including a reference to a command element list of command elements each corresponding to a command which belongs to the category corresponding to the referencing category element.

15. The method of claim 14, further comprising:
receiving a message;
locating in the array of category elements a category element corresponding to the command category identified by the category identifier in the message; and
traversing the command element list referenced by the located category element to access a command element corresponding to the command identified by the command identifier in the received message.

16. The method of claim 14, further comprising:
determining a value of one or more criteria predictive of the content of future messages; and
ordering the command elements within each command element list such that command elements likely to be accessed relatively more frequently are located more quickly than command elements likely to be accessed relatively less frequently.

17. The method of claim 16, wherein determining a value of one or more criteria predictive of the content of future messages comprises:
determining a frequency at which each command is executed.

18. The method of claim 14, further comprising:
parsing the message to extract at least the category identifier and the command identifier.

19. The method of claim 14, further comprising:
invoking a command handler referenced by the accessed command element.

20. An apparatus for processing messages communicated between components in a digital system each message having a category identifier identifying a category of commands, and a command identifier identifying a command which is a member of the category identified by the category identifier, the apparatus comprising:
message handling means for receiving component-generated messages; and
a data structure, accessible by the message handling means, comprising:
at least one list of one or more command elements, wherein the command elements within each list correspond to commands which are members of a same category, and an array of at least one category element each corresponding to a category and including a reference to a command element list, wherein the command elements of the referenced list each correspond to a command which is a member of the category which corresponds to the referencing category element.

21. The apparatus of claim 20, wherein each command element comprises:
a reference to an application specific command handler which executes the command corresponding to that command element.

22. The apparatus of claim 20, further comprising:
message monitoring means for ordering the command elements within each command element list such that command elements likely to be accessed relatively more frequently can be located by the message handler more quickly than command elements likely to be accessed relatively less frequently.

23. The apparatus of claim 20, wherein the messages conform to an intelligent platform management interface (IPMI) protocol.

24. A computer readable medium having a set of computer executable instructions for handling messages communicated between components in a digital system, each message having a category identifier identifying a category of commands, and a command identifier identifying a command which is a member of the category identified by the category identifier, the set of computer-executable instructions comprising:
message handling instructions that receives messages generated by one or more components; and
computer-executable instructions that define an accessible data structure comprising:
at least one list of one or more command elements, wherein the command elements within each list correspond to commands which are members of a same category, and
an array of at least one category element each corresponding to a category and including a reference to a command element list, wherein the command elements of the referenced list each correspond to a command which is a member of the category which corresponds to the referencing category element.

25. The computer readable medium of claim 24, the set of computer executable instructions further comprising:
a message monitoring subsystem that monitors a frequency of occurrence for each command identifier received within a category, and that orders the command elements within a list corresponding to the category according to the monitored frequency for the command identifiers.
